(19) United States
(12) Patent Application Publication
(10) Pub. No.: US 2016/0130847 A1
(43) Pub. Date: May 12, 2016

(54) AROUND-THE-CORNER MULTI-POINT WINDOW LOCK MECHANISM FOR CASEMENT AND AWNING WINDOWS

(71) Applicant: Truth Hardware Corporation, Owatonna, MN (US)

(72) Inventors: Derek Ronald Gramstad, Owatonna, MN (US); Gregory J. Vetter, Owatonna, MN (US)

(21) Appl. No.: 14/539,399

(22) Filed: Nov. 12, 2014

(51) Int. Cl. E05C 9/18; E05D 15/04; E06B 3/36; E05C 9/22; E05B 65/00

(52) U.S. Cl. CPC E05C 9/1833; E05C 9/22; E05B 65/0025; E06B 3/36; E05D 15/04

(57) ABSTRACT

An around-the-corner locking mechanism is mounted using known tie-bar guides so as to cause a self-locating feature for the device on a casement or awning window. The device has an adjustable connecting link so that standard lock system tie bars can be used at industry standard spacings, while also being adaptable to custom sized windows. The mechanism, through an around-the-corner component, has tie bars integrated directly into the around-the-corner component so as to provide a locking point on a casement window jamb at a nearly constant distance from the head or sill of the window, and another linked locking point on the head or sill itself. The tie bars in the around-the-corner component can be linked through an adjustable length linking component to a driving tie bar and slave tie bars to provide still more locking points.

### FIELD OF THE INVENTION

The present invention relates to casement and awning windows, and more specifically to multi-point lock mechanisms for casement and awning windows.

### BACKGROUND OF THE INVENTION

Casement and awning type windows are a popular choice for operable windows in residential and commercial building construction. A common drawback of such windows, however, is that the sash can deflect due to pressure differences between the inside and outside of a structure, for example during high wind conditions. This problem becomes more acute as sashes are made relatively wider, and can lead to failure of the window.

Prior approaches to addressing the problem of sash deflection have involved applying locking mechanisms, not only along the side margin of the sash opposite the hinge, but also along the top and bottom margins of the sash. These approaches have sometimes involved separately actuated control mechanisms for the side locking points and for the locking points along the top and bottom of the sash. A drawback of this approach, however, is that it adds complexity, not only to assembly of the window, but also to operation of the window, since a user must separately operate all the different locking mechanisms.

Another approach has been to link a side locking mechanism to locking points along the top and/or bottom of the sash through an around-the-corner linkage. A drawback of such known linkages, however, is that they are not easily adjustable or variable so as to account for different window sizes. Further, they can be difficult to properly locate on the window frame during installation.

Accordingly, what is needed is a window locking system that enables simultaneous engagement of locking points on the sides and top and/or bottom of a casement or awning window, yet is easily adjusted and installed.

### SUMMARY OF THE INVENTION

Embodiments of the present invention address the need for a window locking system that enables simultaneous engagement of locking points on the sides and top and/or bottom of a casement or awning window, yet is easily adjusted and installed.

According to embodiments of the invention, an around-the-corner locking mechanism is mounted using known tie-bar guides so as to cause a self-locating feature for the device on a casement or awning window. The device has an adjustable connecting link so that standard lock system tie bars can be used at industry standard spacings, while also being adaptable to custom sized windows. The mechanism, through an around-the-corner component, has tie bars integrated directly into the around-the-corner component so as to provide a locking point on a casement window jamb at a nearly constant distance from the head or sill of the window, and another linked locking point on the head or sill itself. The tie bars in the around-the-corner component can be linked to a driving tie bar and slave tie bars to provide still more locking points.

The final absolute position of these locking points can be varied by varying the distance of the tie bar guides from the frame members through height of the tie bar guide bases or with shims, and the position of the locking points relative to the sash can be varied with tabs extending from the tie bar guides. In addition, the housing of the around-the-corner component can be made flexible to accommodate window frame members that are not oriented at right angles to each other.

Accordingly, according to an embodiment of the invention, a multi-point locking mechanism for a window includes an around-the-corner drive with a housing having a first portion and a second portion disposed at an angle relative to the first portion, the first portion and the second portion each defining a channel, the around-the-corner drive further including a flexible drive ribbon slidably disposed in the channel. The mechanism further includes a pair of tie bar guides, a first one of the tie bar guides coupled to the first portion of the housing and a second one of the tie bar guides coupled to the second portion of the housing, each of the tie bar guides defining a channel. The mechanism also has a pair of tie bars, one of the tie bars slidably disposed through the channel of the first tie bar guide and operably coupled to a first end of the flexible drive ribbon, the other tie bar guide disposed through the channel of the second tie bar guide and operably coupled to a second end of the flexible drive ribbon. The flexible drive ribbon can be at least one steel band and a polymer component. Each of the tie bars can present a locking point.

In an embodiment, the mechanism can further include at least one adjustable length connecting link operably coupled to one of the tie bars. The adjustable length connecting link can define a plurality of fastener holes and a laterally oriented score line registered with each of the fastener holes, the adjustable length connecting link being adapted to fracture at the score lines to enable permanent alteration of a length dimension of the adjustable length connecting link.

The mechanism can include at least one keeper. The tie bar guides can have a tab portion arranged to abut the frame and thereby space the tie bars predetermined distance apart from the frame, and/or a base portion arranged to space the tie bars apart from the frame.

In a further embodiment, a window system includes a frame defining an opening, a sash hinged to the frame and selectively shiftable to close the opening, and a multi-point locking mechanism for latching the sash to the frame. The mechanism can include an around-the-corner drive including a housing having a first portion and a second portion disposed at an angle relative to the first portion, the first portion and the second portion each defining a channel, the around-the-corner drive further including a flexible drive ribbon slidably disposed in the channel. The mechanism may further include a pair of tie bar guides, a first one of the tie bar guides coupled to the first portion of the housing and attached to a first portion of the frame, a second one of the tie bar guides coupled to the second portion of the housing and attached to a second portion of the frame disposed at an angle to the first portion of the frame, each of the tie bar guides defining a channel. The mechanism can further include a pair of tie bars, one of the tie bars slidably disposed through the channel of the first tie bar guide and operably coupled to a first end of the flexible drive ribbon, the other tie bar guide disposed through the channel of the second tie bar guide and operably coupled to a second end of the flexible drive ribbon, each of the tie bars presenting a locking point, and a pair of keepers operably coupled to the sash, wherein the tie bars and the flexible drive ribbon are selectively slidably shiftable to engage and disengage the locking points from the keepers.

In an embodiment, the window system can include at least one adjustable length connecting link operably coupled to one of the tie bars. The adjustable length connecting link may define a plurality of fastener holes and a laterally oriented score line registered with each of the fastener holes, the adjustable length connecting link being adapted to fracture at the score lines to enable permanent alteration of a length dimension of the adjustable length connecting link.

In a further embodiment, the system may include a control lever and a driving tie bar coupled to the control lever, with the adjustable length connecting link operably coupling one of the tie bars of the locking mechanism to the driving tie bar. The system can include a second adjustable length connecting link and a slave tie bar, the slave tie bar operably coupling the other one of the tie bars of the mechanism to the slave tie bar.

### BRIEF DESCRIPTION OF THE FIGURES

The embodiments of the present invention may be more completely understood in consideration of the following detailed description of various embodiments in connection with the accompanying drawings, in which:

FIG. 1 is a front perspective view of a casement window;

FIG. 2 is a partial isometric view of a window locking mechanism according to an embodiment of the invention as mounted on a casement window;

FIG. 3 is a partial isometric view of a window locking mechanism according to another embodiment of the invention as mounted on a casement window;

FIG. 4 is a partial isometric view of the around-the-corner drive of a mechanism according to an embodiment of the invention as mounted on a casement window;

FIG. 5 is a partial isometric view of the around-the-corner drive of FIG. 4 with the housing of the device depicted in phantom so as to show the flexible drive ribbon;

FIG. 6 is a partial isometric view of a window locking mechanism according to another embodiment of the invention as mounted on a casement window;

FIG. 7a is an isometric view of a window locking mechanism according to an embodiment of the invention with one configuration of tie bar guides;

FIG. 7b is an isometric view of the window locking mechanism of FIG. 7a with another configuration of tie bar guides;

FIG. 8a is a side elevation view of the window locking mechanism of FIG. 7a;

FIG. 8b is a side elevation view of the window locking mechanism of FIG. 7b;

FIG. 9 is a partial cross-sectional view of the window locking mechanism of FIG. 7a, taken at section 9-9 and mounted on a casement window;

FIG. 10 is a partial cross-sectional view the window locking mechanism of FIG. 7b taken at section 10-10 and mounted on a casement window;

FIG. 11 is an isometric view of the link portion of the window locking mechanism of FIG. 2 taken at inset 11;

FIG. 12 is an isometric view of a window locking mechanism according to an embodiment of the invention with a shortened link member; and

FIG. 13 is an isometric view of two window locking mechanisms according to embodiments of the invention in which a housing of one of the mechanisms has been flexed to accommodate a window in which the window frame has a jamb member that is not perpendicular with the sill.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION

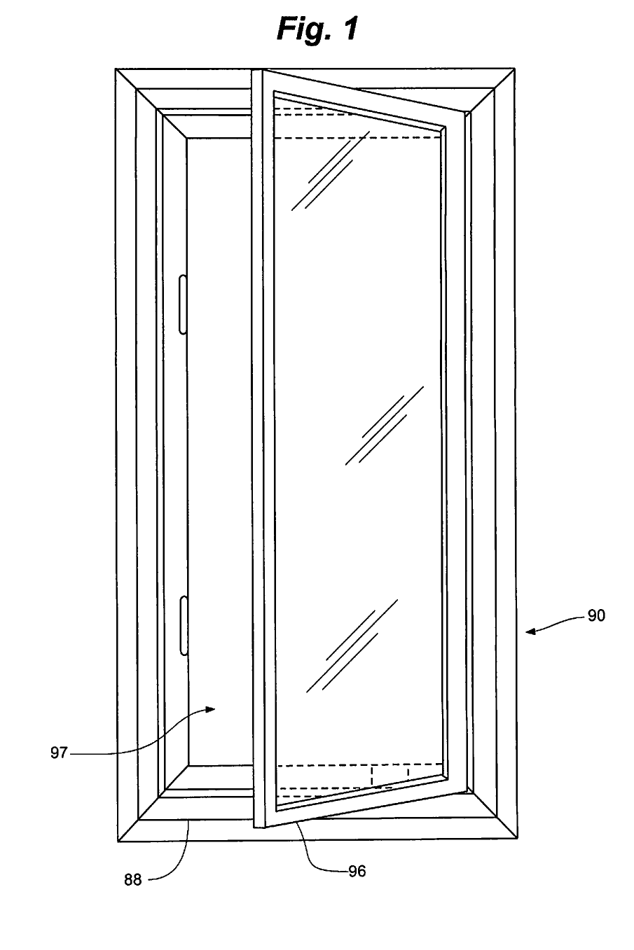

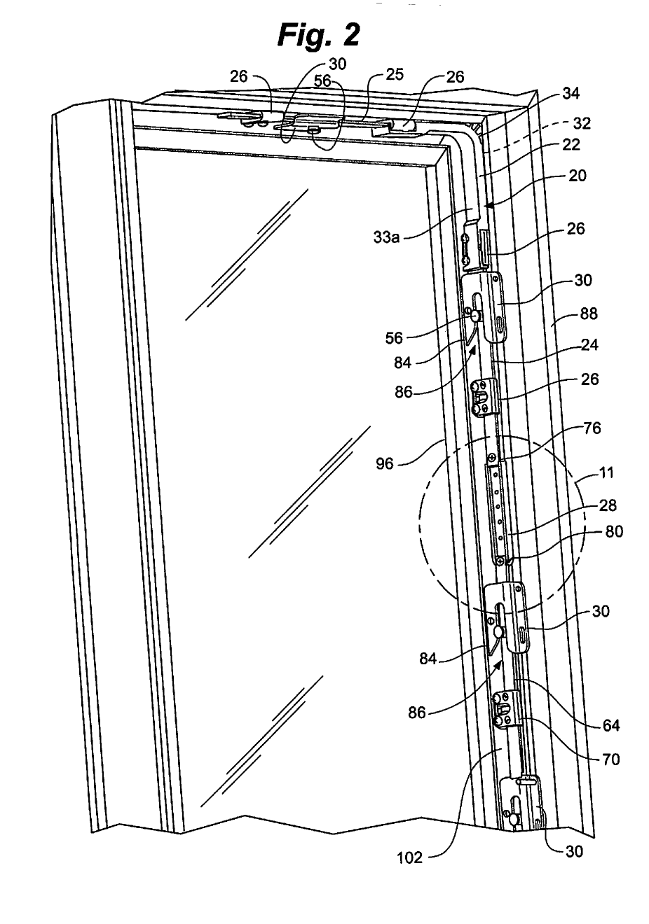

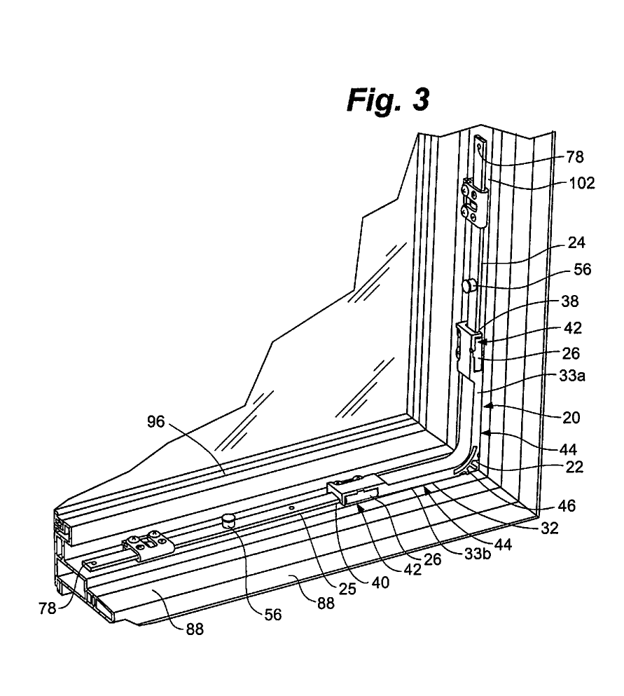

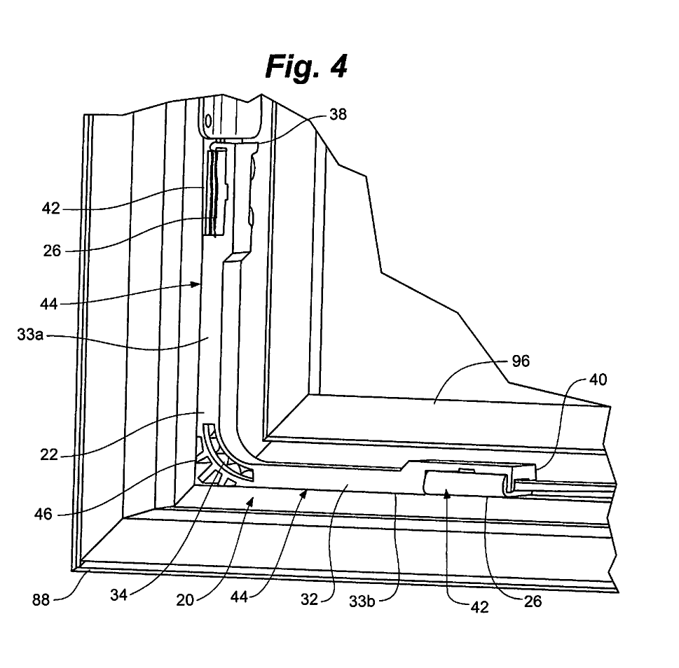

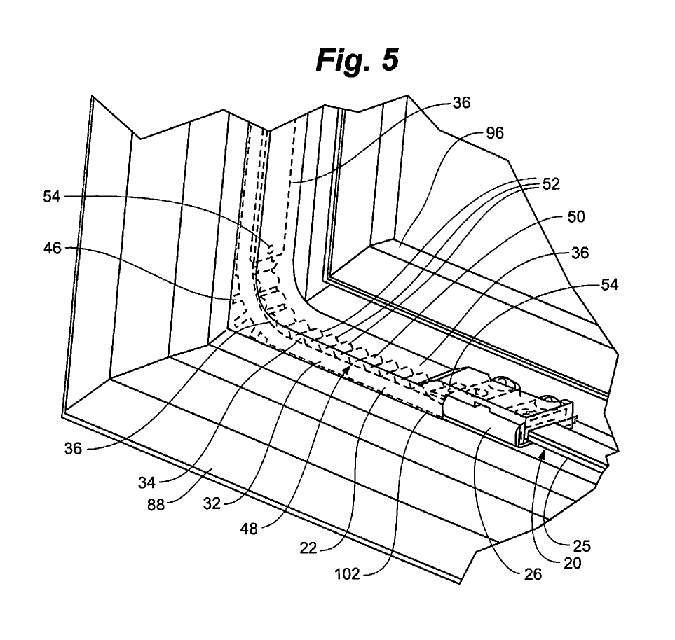

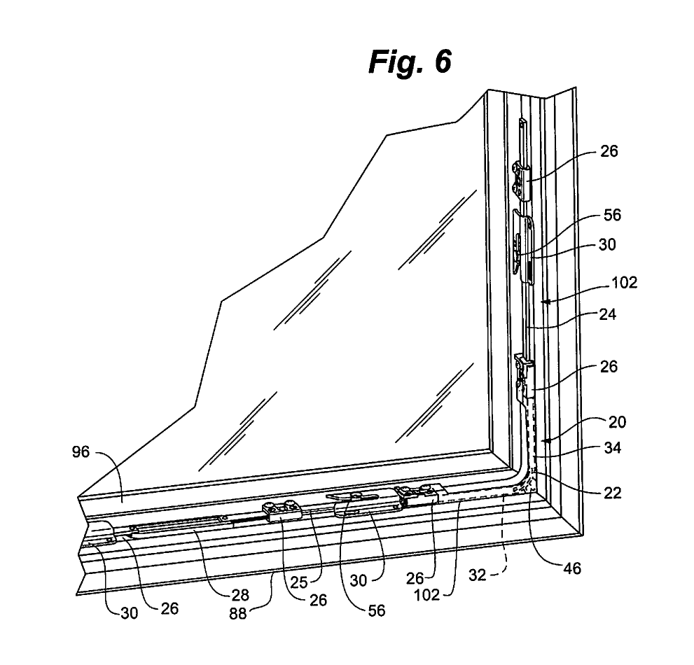

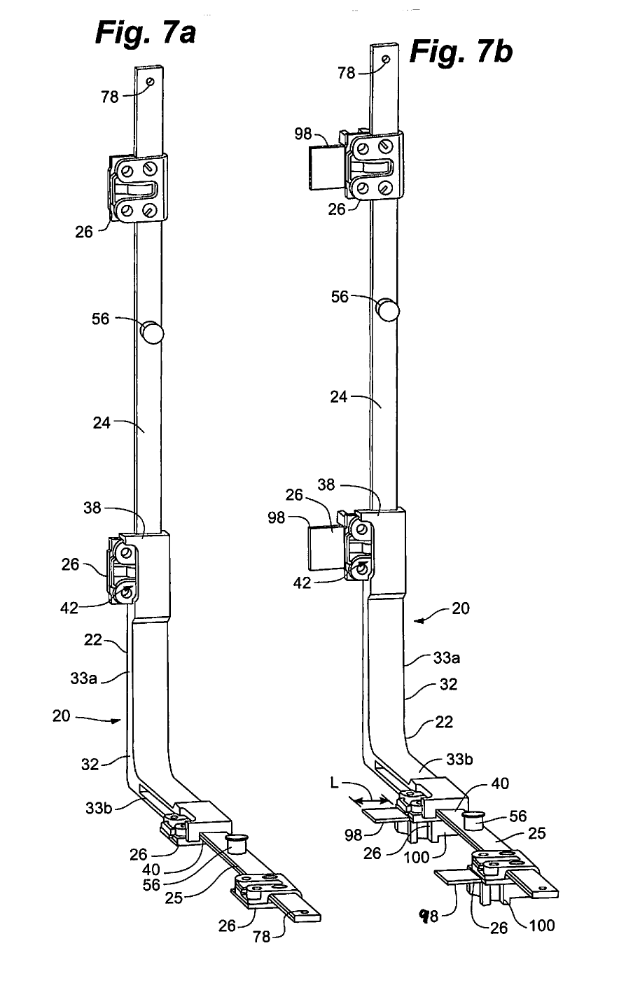

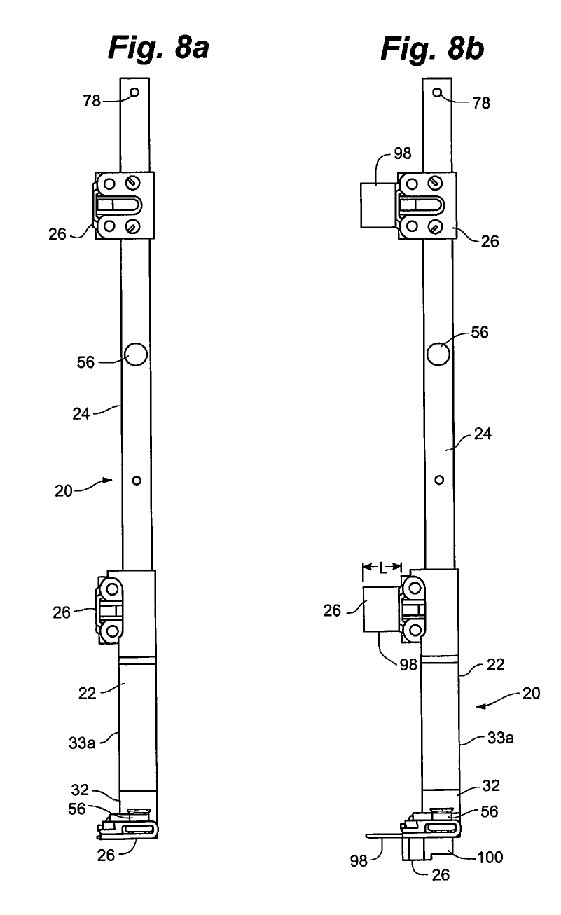

Embodiments of a multi-point window locking mechanism 20 for casement and awning windows are depicted in FIGS. 1-13. Mechanism 20 generally includes around-the-corner drive 22, tie bars 24, 25, tie bar guides 26, adjustable length connecting link 28, and keepers 30. Around-the-corner drive 22 generally includes housing 32 and flexible drive ribbon 34. Housing 32 has a first portion or leg 33a and a second portion or leg 33b, and defines enclosed channel 36 through portions 33a, 33b, extending from first end 38 to second end 40. Housing 32 also defines and tie bar guide receiving recesses 42. Housing 32 may also have corner ribs 46 extending outwardly from bottom side 44.

Flexible drive ribbon 34 generally includes base steel band 48, accompanied by flexible polymer spacer component 50 in order to inhibit buckling. Polymer spacer layer 50 defines laterally oriented ridges 52, which can serve to take up excess clearance between flexible drive ribbon 34 and the walls of channel 36. It will be appreciated, however, that flexible drive ribbon 34 could be any other flexible structure or material that has sufficient rigidity and strength to transmit the forces applied during lock point actuation. Further, it will be appreciated that more than one steel band 48 can be provided as desired to provide additional rigidity and strength. Flexible drive ribbon 34 is slidably received in channel 36 of housing 32.

Tie bars 24, 25, extend into first end 38 and second end 40 respectively of channel 36, and are coupled to flexible drive ribbon 34 with rivets 54. Each of tie bars 24, 25, presents a lock point 56, having a barrel portion 58, and a larger diameter head portion 60.

Tie bar guides 26 can be known tie bar guide components such as are disclosed in U.S. Published Patent Application No. 2012/0146342 A1, entitled SELF LOCATING TIE BAR GUIDE FOR SASH LOCK TIE BARS, said application being hereby fully incorporated herein by reference. As an alternative, tie-bar guides 26 can be any other similar tie bar guide component. Each of tie bar guides 26 is received in one of tie bar guide recesses 42. Tie bar 24, 25, extends through, and is slidably guided in channel 62 defined in the tie bar guide 26. Each tie bar 24, 25, can be coupled to a tie bar 64, 66, mounted to a casement window frame 68 with further tie bar guides 70. At least one of the tie bars 64, 66, can be a driving tie bar that is slidably shifted by a control lever (not depicted), as disclosed in U.S. Pat. No. 7,452,014 B2, entitled MULTI-POINT SASH LOCK SYSTEM FOR CASEMENT WINDOW, said patent being fully incorporated herein by reference. The other tie bar can be a so-called “slave” tie bar that is not coupled to any separate control lever, but is instead shifted by the driving tie bar through mechanism 20. Each of tie bars 64, 66, include one or more lock points 56, again having a barrel portion 58, and a larger diameter head portion 60. Tie bars 24, 25, are coupled to tie bars 64, 66, with adjustable length connecting links 28. Each of adjustable length connecting links 28 defines a plurality of fastener holes 72. Connecting link 28 may be made from polymer material, and may have a transversely oriented score line 74 registered with each fastener hole, so that the length of the link 28 can be permanently altered by breaking the link at any of the score lines 74. Tie bars 24, 25, can be coupled to connecting link 28 with a screw 76 or other suitable fastener through aperture 78 in tie bar 24, 25, and one of fastener holes 72. Similarly, tie bars 64, 66, are coupled to connecting link 28 with a screw 80 or other similar fastener through aperture 82 in tie bar 64, 66, and another of fastener holes 72. Each of keepers 30 generally includes hook portion 84 defining slot 86.

In use, mechanism 20 is attached to frame 88 of a casement window 90 with screws 92 through fastener holes 94 in tie bar guides 26. Each tie bar 24, 25, of mechanism 20 is coupled to a separate one of tie bars 64, 66, with connecting link 28 as described hereinabove. As is known in the art and depicted in FIG. 1, swinging sash 96 of casement window 90 is coupled to frame 88 with hinges (not depicted). Each of keepers 30 are attached to swinging sash 96 of casement window 90 with slot 86 registered with one of lock points 56. With the sash 96 in the closed position, that is closing the opening 97 defined by the frame 88, the control lever coupled to the primary tie bar can be actuated to longitudinally slide the primary tie bar, which in turn, slides tie bar 24, flexible drive ribbon 34 of around-the-corner drive 22, and tie bar 25, which are all coupled together. Accordingly, each lock point 56 is shifted into engagement in a slot 86 of one of keepers 30, thereby locking sash 96 in place in frame 88 and inhibiting sash 96 from being opened. When it is desired to open sash 96, the control lever can be actuated in the opposite direct to shift lock points 56 out of slots 86.

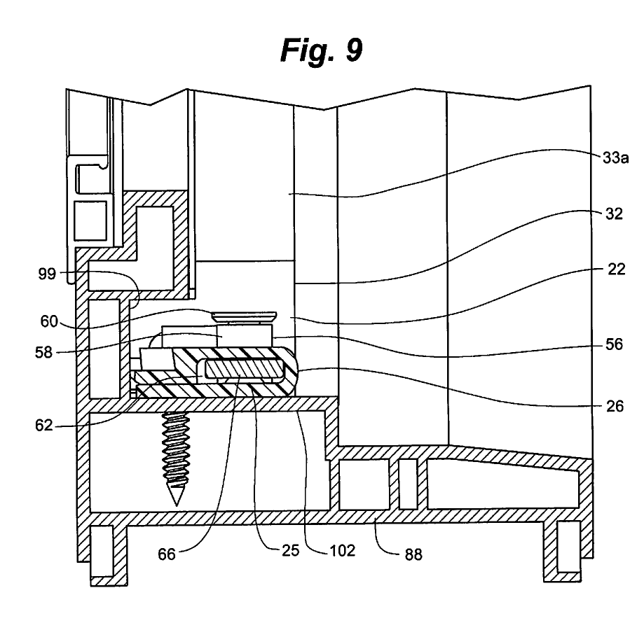

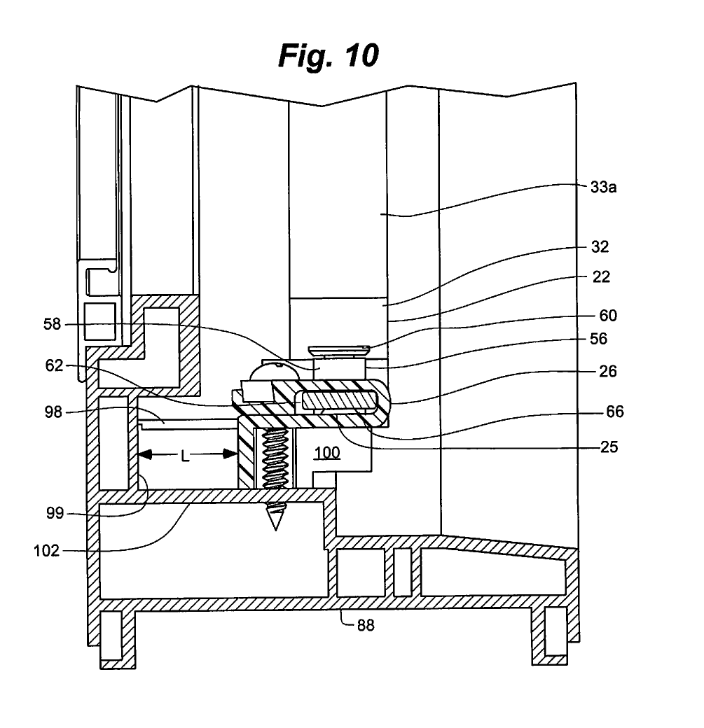

Several features of the disclosed lock mechanism facilitate adjustability of the mechanism 20 to easily accommodate different size windows or different window geometries. For example, since mechanism 20 is mounted using tie bar guides 26, the selection of different tie bar guides can accommodate mounting of the mechanism 20 in any desired location relative to the frame and sash. As depicted in FIG. 10, where it is desired to mount mechanism 20 spaced apart a relatively greater distance from sash 96, tie bar guide 26 can include a tab 98 with a length L corresponding to the desired spacing that can be abutted with a vertical wall 99 of the frame 88. Of course, tab 98 can be made to any different length, or omitted entirely as depicted in FIG. 9, where it is desired to mount mechanism 20 relatively closer to sash 96. Thus, by simply abutting the tie bar guide against a vertical wall of the frame, the entire assembly is automatically located at a desired position on the frame relative to the sash and is correctly aligned.

Similarly, tie bar guide 26 can include an elevated base 100 where it is desired to mount tie bars 24, 25, a relatively greater distance from peripheral wall 102 of frame 88. Alternatively, base 100 can be omitted entirely as depicted in FIG. 9, where it is desirable to mount tie bars 24, 25, a relatively lesser distance from peripheral wall 102 of frame 88. In addition, shims (not depicted) can be inserted between tie bar guides 26 and frame 88 to achieve other spacings.

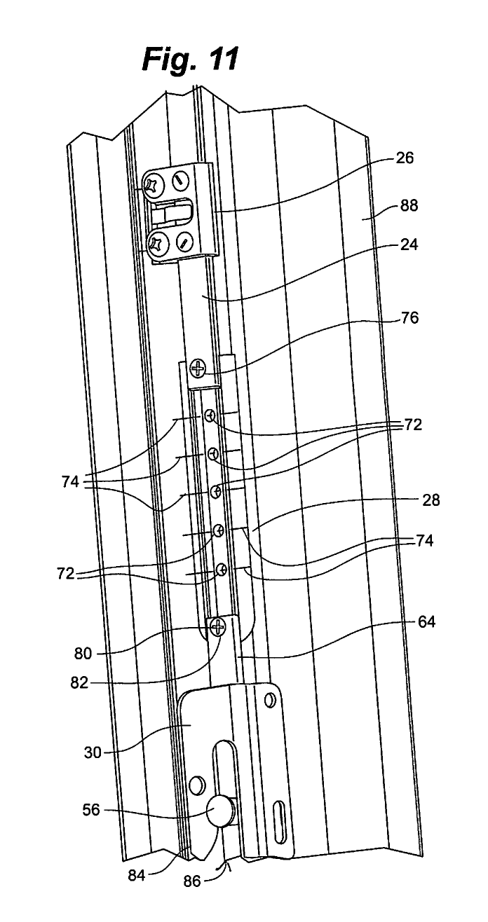

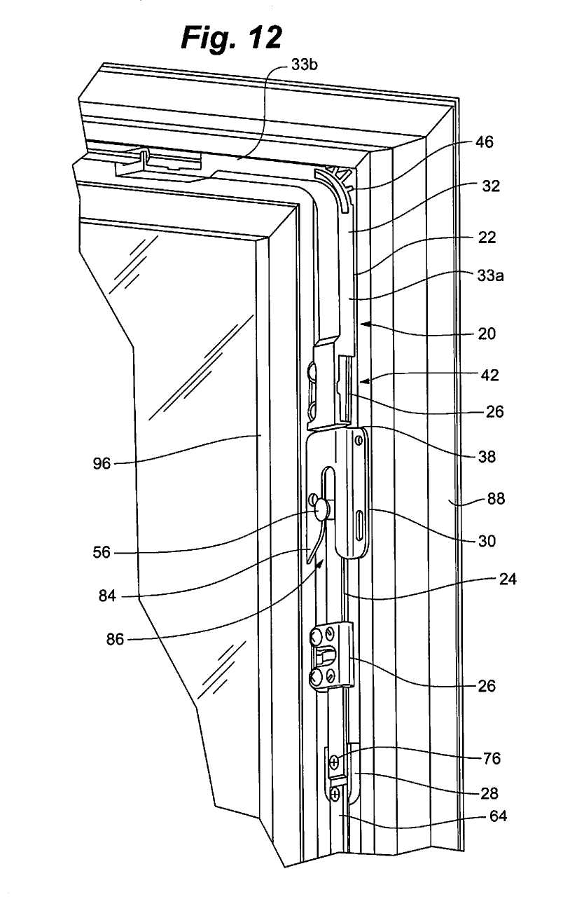

Adjustable length connecting link 28 provides further flexibility in mounting mechanism 20. For larger windows, where the spacing between the ends of tie bars 24, 25, and tie bars 64, 66, may be relatively greater, link 28 can be used with its full length as depicted in FIG. 11. For smaller windows where the spacing between the ends of tie bars 24, 25, and tie bars 64, 66, may be relatively lesser, link 28 may be altered in length by breaking at one of score lines 74 to result in a shorter link as depicted in FIG. 12.

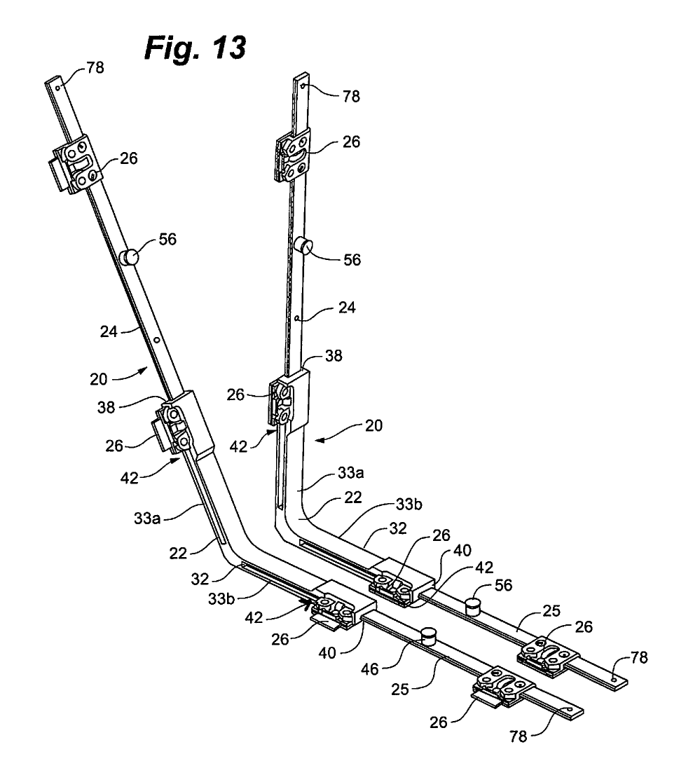

Moreover, housing 32 of around-the-corner drive 22 may itself be made flexible as depicted in FIG. 13 so as to accommodate frames 88 forming angles different than 90 degrees, such as may be encountered in hexagonal or other polygon shaped windows. With the features described above, it will be appreciated that mechanism 20 can be easily adjusted to accommodate virtually any size or shape of window, while also enabling easy location and mounting of the mechanism on the window during assembly.

The foregoing descriptions present numerous specific details that provide a thorough understanding of various embodiments of the invention. It will be apparent to one skilled in the art that various embodiments, having been disclosed herein, may be practiced without some or all of these specific details. In other instances, components as are known to those of ordinary skill in the art have not been described in detail herein in order to avoid unnecessarily obscuring the present invention. It is to be understood that even though numerous characteristics and advantages of various embodiments are set forth in the foregoing description, together with details of the structure and function of various embodiments, this disclosure is illustrative only. Other embodiments may be constructed that nevertheless employ the principles and spirit of the present invention. Accordingly, this application is intended to cover any adaptations or variations of the invention.

For purposes of interpreting the claims for the present invention, it is expressly intended that the provisions of 35 U.S.C. §112(f) are not to be invoked unless the specific terms “means for” or “step for” are recited in a claim.

What is claimed is:

1. A multi-point locking mechanism for a window, the mechanism comprising:
an around-the-corner drive including a housing having a first portion and a second portion disposed at an angle relative to the first portion, the first portion and the second portion each defining a channel, the around-the-corner drive further including a flexible drive ribbon slidably disposed in the channel;
a pair of tie bar guides, a first one of the tie bar guides coupled to the first portion of the housing and a second one of the tie bar guides coupled to the second portion of the housing, each of the tie bar guides defining a channel;
a pair of tie bars, one of the tie bars slidably disposed through the channel of the first tie bar guide and operably coupled to a first end of the flexible drive ribbon, the other tie bar guide disposed through the channel of the second tie bar guide and operably coupled to a second end of the flexible drive ribbon.

2. The multi-point locking mechanism of claim 1, wherein the flexible drive ribbon comprises at least one steel band.

3. The multi-point locking mechanism of claim 2, wherein the flexible drive ribbon further comprises a polymer component.

4. The multi-point locking mechanism of claim 1, wherein each of the tie bars presents a locking point.

5. The multi-point locking mechanism of claim 1, further comprising at least one adjustable length connecting link operably coupled to one of the tie bars.

6. The multi-point locking mechanism of claim 5, wherein the adjustable length connecting link defines a plurality of fastener holes and a laterally oriented score line registered with each of the fastener holes, the adjustable length connecting link being adapted to fracture at the score lines to enable permanent alteration of a length dimension of the adjustable length connecting link.

7. The multi-point locking mechanism of claim 1, further comprising at least one keeper.

8. The multi-point locking mechanism of claim 1, wherein the tie bar guides have a tab portion arranged to abut the frame and thereby space the tie bars predetermined distance apart from the frame.

9. The multi-point locking mechanism of claim 1, wherein the tie bar guides have a base portion arranged to space the tie bars apart from the frame.

10. A window system comprising:
a frame defining an opening;
a sash hinged to the frame and selectively shiftable to close the opening;
a multi-point locking mechanism for latching the sash to the frame, the mechanism comprising:
an around-the-corner drive including a housing having a first portion and a second portion disposed at an angle relative to the first portion, the first portion and the second portion each defining a channel, the around-the-corner drive further including a flexible drive ribbon slidably disposed in the channel;
a pair of tie bar guides, a first one of the tie bar guides coupled to the first portion of the housing and attached to a first portion of the frame, a second one of the tie bar guides coupled to the second portion of the housing and attached to a second portion of the frame disposed at an angle to the first portion of the frame, each of the tie bar guides defining a channel;
a pair of tie bars, one of the tie bars slidably disposed through the channel of the first tie bar guide and operably coupled to a first end of the flexible drive ribbon, the other tie bar guide disposed through the channel of the second tie bar guide and operably coupled to a second end of the flexible drive ribbon, each of the tie bars presenting a locking point;
a pair of keepers operably coupled to the sash, wherein the tie bars and the flexible drive ribbon are selectively slidably shiftable to engage and disengage the locking points from the keepers.

11. The window system of claim 10, wherein the flexible drive ribbon comprises at least one steel band.

12. The window system of claim 11, wherein the flexible drive ribbon further comprises a polymer component.

13. The window system of claim 10, further comprising at least one adjustable length connecting link operably coupled to one of the tie bars.

14. The window system of claim 13, wherein the adjustable length connecting link defines a plurality of fastener holes and a laterally oriented score line registered with each of the fastener holes, the adjustable length connecting link being adapted to fracture at the score lines to enable permanent alteration of a length dimension of the adjustable length connecting link.

15. The window system of claim 13, further comprising a control lever and a driving tie bar coupled to the control lever, the adjustable length connecting link operably coupling one of the tie bars of the locking mechanism to the driving tie bar.

16. The window system of claim 15, further comprising a second adjustable length connecting link and a slave tie bar, the slave tie bar operably coupling the other one of the tie bars of the mechanism to the slave tie bar.

17. The window system of claim 10, wherein the tie bar guides have a tab portion arranged to abut the frame and thereby space the tie bars predetermined distance apart from the frame.

18. The window system of claim 10, wherein the tie bar guides have a base portion arranged to space the tie bars apart from the frame.
